(19) United States
(12) Patent Application Publication
(10) Pub. No.: US 2013/0281631 A1
(43) Pub. Date: Oct. 24, 2013

(54) PHOSPHONIC ACID POLYMER, PRODUCTION METHOD OF SAME, AND ELECTROLYTE FILM FUEL CELL

(71) Applicants: Satoshi Nakazawa, Susono-shi (JP); Mitsuru Ueda, Minato-ku (JP); Tomoya Higashihara, Ota-ku (JP); Namiko Fukuzaki, Yokohama-shi (JP)

(72) Inventors: Satoshi Nakazawa, Susono-shi (JP); Mitsuru Ueda, Minato-ku (JP); Tomoya Higashihara, Ota-ku (JP); Namiko Fukuzaki, Yokohama-shi (JP)

(73) Assignee: TOYOTA JIDOSHA KABUSHIKI KAISHA, Toyota-shi, Aichi-ken (JP)

(21) Appl. No.: 13/880,063

(22) PCT Filed: Oct. 13, 2011
(86) PCT No.: PCT/IB2011/002407

§ 371 Date: Jun. 21, 2013

(30) Foreign Application Priority Data
Oct. 19, 2010 (JP) 2010-234610
Apr. 8, 2011 (JP) 2011-086253

(51) Int. Cl. C08F 30/02

(52) U.S. Cl. CPC C08F 30/02
USPC 525/326.2; 526/245

(57) ABSTRACT

A phosphoric acid polymer containing a repeating unit represented by the following formula (1):

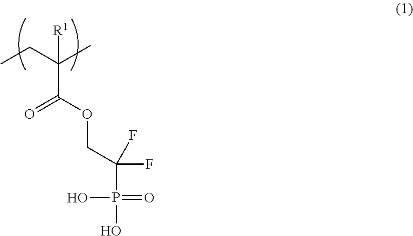

(wherein, R¹ represents a hydrogen atom or methyl, group).

### BACKGROUND OF THE INVENTION

1. Field of the Invention

The invention relates to a phosphonic acid polymer, a production method thereof, and an electrolyte film for a fuel cell.

2. Description of Related Art

Perfluorosulfonic acid-based polymers as represented by Nafion® are widely used as electrolyte films for polymer electrolyte fuel cells. However, since perfluorosulfonic acid-based polymers are extremely expensive, various proposals have been made regarding alternative materials thereto. One of these is a phosphonic acid polymer having phosphate groups introduced into a polymer side chain. An example of such a phosphonic acid polymer is disclosed in Japanese Patent Application Publication No. 2003-257238 (JP-A-2003-257238), and has phosphate groups introduced into the aromatic ring of polystyrene through methylene groups.

However, the phosphonic acid polymer disclosed in JP-A-2003-257238 has an aromatic group having a large molecular weight in repeating units thereof. Consequently, the polymer dry weight (EW value) per mole of phosphate groups is relatively large, thereby resulting in the problem of decreased proton conductivity in comparison with phosphonic acid polymers of a structure that does not have an aromatic ring.

### SUMMARY OF THE INVENTION

This invention provides a phosphonic acid polymer having a high proton conductivity, a production method thereof, and an electrolyte film for a fuel cell.

A first aspect of the invention is a phosphonic acid polymer containing a repeating unit represented by the following formula (1):

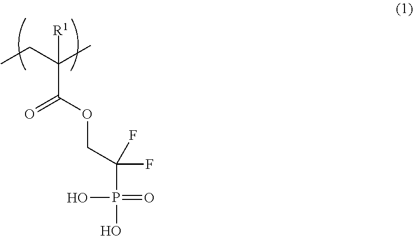

(wherein, R¹ represents a hydrogen atom or methyl group).

In addition, the electrolyte film for a fuel cell may contain the above-mentioned phosphonic acid polymer.

In addition, the electrolyte film for a fuel cell may also contain a crosslinked form of the above-mentioned phosphonic acid polymer.

In addition, a second aspect of the invention is a production method of a phosphonic acid polymer, provided with: a step of reacting a reducing agent with a carboxyl group-containing compound represented by the following formula (2) to obtain a hydroxymethyl group-containing compound represented by the following formula (3), a step of reacting a (meth)acrylate halide compound or (meth)acrylic anhydride halide compound with the hydroxymethyl group-containing compound to obtain a (meth)acrylic acid-based compound represented by the following formula (4), a step of addition-polymerizing the (meth)acrylic acid-based compound to obtain a polymer precursor containing a repeating unit represented by the following formula (5):

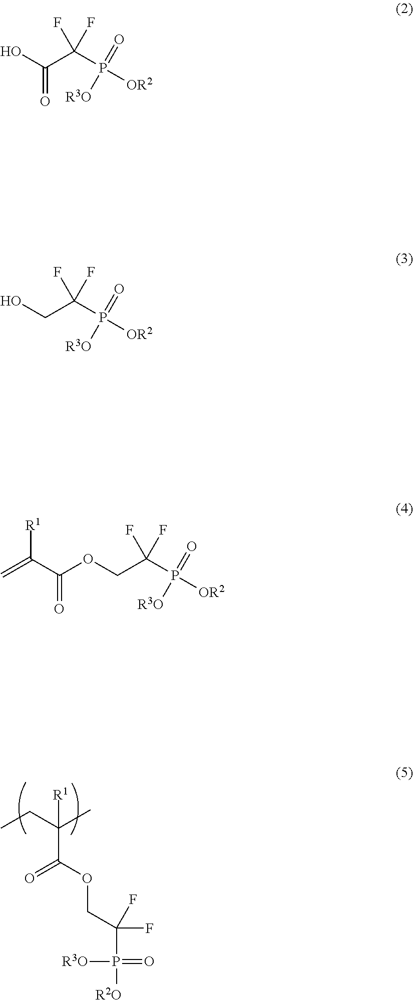

(wherein, R¹ represents a hydrogen atom or methyl group, and R² and R³ respectively and independently represent a linear or branched alkyl group having 1 to 5 carbon atoms), and a step of hydrolyzing an ester moiety of the polymer precursor.

According to the invention, a phosphonic acid polymer having a high proton conductivity, a production method thereof, and an electrolyte film for a fuel cell can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a ¹H-NMR chart of compound (A) obtained in Synthesis Example 1;

FIG. 2 is a ¹H-NMR chart of compound (B) obtained in Synthesis Example 1;

FIG. 3 is a ¹H-NMR chart of compound (C) obtained in Synthesis Example 1;

FIG. 4 is a ¹H-NMR chart of compound (D) obtained in Synthesis Example 1;

FIG. 5 is a ¹H-NMR chart of compound (E) obtained in Synthesis Example 1;

FIG. 6 is a ³¹P-NMR chart of compound (E) obtained in Synthesis Example 1;

FIG. 7 is a ¹⁹F-NMR chart of compound (E) obtained in Synthesis Example 1;

FIG. 8 is a ¹H-NMR chart of compound (F) obtained in Synthesis Example 2;

FIG. 9 is a ¹H-NMR chart of compound (G) obtained in Synthesis Example 2;

FIG. 10 is a ¹H-NMR chart of compound (H) obtained in Synthesis Example 2;

FIG. 11 is a ¹H-NMR chart of compound (I) obtained in Synthesis Example 2;

FIG. 12 is a graph of proton conductivity of film samples produced from compound (E) and compound (I), respectively, that was measured while changing humidity;

FIG. 13 is a graph of proton conductivity of a film sample produced by crosslinking compound (E) that was measured while changing humidity; and

FIG. 14 is a graph indicating the relationship between moisture absorption λ and proton conductivity of a film sample produced by crosslinking compound (E).

### DETAILED DESCRIPTION OF EMBODIMENTS

[Phosphonic Acid Polymer]

First, an explanation is provided of the phosphonic acid polymer of an embodiment of the invention. The phosphonic acid polymer of the embodiment contains a repeating unit represented by the following formula (1):

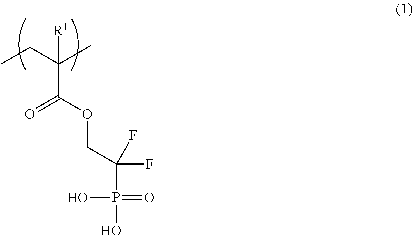

(wherein, R¹ represents a hydrogen atom or methyl group).

As shown in formula (1), since the phosphonic acid polymer of the embodiment does not contain an aromatic ring in the repeating unit thereof, it can be made to have a smaller EW value than that which contains an aromatic ring. In addition, since the phosphonic acid polymer has a methyl fluoride group adjacent to the phosphate group, it is able to strongly attract the negative charge of the phosphate group. Consequently, in comparison with a structure having an alkyl group adjacent to the phosphate group, protons of the phosphate group can be easily dissociated. Thus, although the details thereof will be subsequently described in the examples, this phosphonic acid polymer is able to demonstrate high proton conductivity.

[Production Method of Phosphoric Acid Polymer]

Next, an explanation is provided of the production method of the phosphonic acid polymer of the embodiment. The phosphonic acid polymer is produced according to the following Steps 1 to 4.

(Step 1)

The first step is a step of reacting a reducing agent with a carboxyl group-containing compound represented by the following formula (2) to obtain a hydroxymethyl group-containing compound represented by the following formula (3):

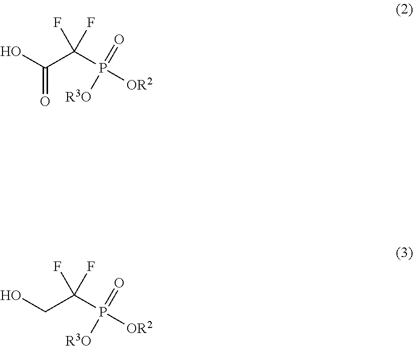

(wherein, R² and R³ respectively and independently represent a linear or branched alkyl group having 1 to 5 carbon atoms).

In formulas (2) and (3), R² and R³ represent phosphoric acid protecting groups. Although ethyl groups are used for both R² and R³, linear or branched alkyl groups having 1 to 5 carbon atoms may also be used, examples of which include methyl groups, n-propyl groups, i-propyl groups, n-butyl groups, t-butyl groups and n-pentyl groups.

The compound of formula (2) is obtained by subjecting an ester compound of difluoromethane phosphoric acid (HCF₂PO(OH)₂) to a carboxylation reaction. This carboxylation reaction is described in, for example, J. Chem. Soc., Perkin I, 1999 (1051-1056).

A reducing agent having comparatively weak reducing power is used for the reducing agent that reacts with the compound of formula (2), examples of which include B₂H₆, NaBH₄ and NaBH₃CN. The use of such a reducing agent makes it possible to selectively reduce the carboxyl group in the above-mentioned compound. Although the amount of the reducing agent used is normally 2 moles to 10 moles with respect to 1 mole of the compound of formula (2), the amount used may also be 0.5 moles to 10 moles.

This step is carried out in the presence of an organic solvent. Although an ether-based solvent such as tetrahydrofuran, diethyl ether, methyl-tert-butyl ether, 1,4-dioxane or 1,2-dimethoxyethane is used in this step, aliphatic hydrocarbon solvents such as hexane, heptane or cyclohexane, aromatic solvents such as toluene, xylene, monochlorobenzene or dichlorobenzene, or halogenated hydrocarbon solvents such as dichloromethane, dichloroethane or chlorobutane may also be used. In addition, these solvents may be used alone or two or more solvents may be used simultaneously. Although the amount of the organic solvent used is normally 2 times to 20 times the weight of the compound of formula (2), the amount used may also be 1 time to 100 times the weight of the compound of formula (2).

The reaction between the compound of formula (2) and the reducing agent is carried out according to a method in which the reducing agent is gradually added to a mixture containing the compound of formula (2) and an organic solvent. More specifically, a mixture containing the compound of formula (2) and the organic solvent is first held at a temperature of about −40° C. to 10° C. Next, while the reducing agent is added to this mixture, the mixture is heated so that the temperature thereof is increased to room temperature. Thus, a reaction is caused. The duration of the reaction can be suitably adjusted within the range of 1 hour to 48 hours. Progression of the reaction can be confirmed by, for example, gas chromatography (GC), high-performance liquid chromatography (HPLC), thin layer chromatography (TLC), IR or NMR.

The reaction solution is then mixed with water and subjected to liquid separation treatment by mixing with an organic solvent able to be separated from water. In this step, although an ester solvent such as methyl acetate, ethyl acetate or butyl acetate is used for the organic solvent able to be separated from water, an aliphatic hydrocarbon solvent such as hexane, heptane or cyclohexane, an aromatic solvent such as toluene, xylene, monochlorobenzene or dichlorobenzene, an ether solvent such as methyl-tert-butyl ether or 1,2-dimethoxyethane, a halogenated hydrocarbon solvent such as dichloromethane, dichloroethane or chlorobutane, or a ketone solvent such as methyl ethyl ketone or methyl isobutyl ketone may also be used. Although there are no particular limitations on the amounts of water and organic solvent used in liquid separation treatment, the water and organic solvent can be used in the amounts required to dissolve inorganic substances formed due to hydrolysis of the reducing agent, for example. The organic layer following liquid separation treatment is washed using water and an acidic aqueous solution, and then dehydrated and filtered as necessary.

(Step 2)

The second step is a step of reacting the compound of formula (3) with a (meth)acrylate halide compound or (meth)acrylic anhydride halide compound to obtain the (meth)acrylic acid-based compound represented by the following formula (4):

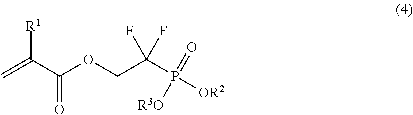

(wherein, R¹ represents a hydrogen atom or methyl group, and R² and R³ respectively and independently represent a linear or branched alkyl group having 1 to 5 carbon atoms).

Although the compound of formula (3) is reacted with a (meth)acrylate chloride in this step, (meth)acrylate bromide or (meth)acrylate iodide may be used instead of (meth)acrylate chloride, or (meth)acrylic anhydride, a mixed acid anhydride of acrylic acid and methacrylic acid, or a mixed acid anhydride of (meth)acrylic acid and another acid may also be used. The reaction may also be carried out by adding a condensation agent such as dicyclohexylcarbodiimide (DCC) to (meth)acrylic acid. In the case of using (meth)acrylate chloride or a (meth)acrylic anhydride halide compound, although the amount of the (meth)acrylate halide compound or the (meth)acrylic anhydride halide compound used is normally 1.5 moles to 5 moles with respect to 1 mole of the compound of formula (3), the amount used may also be 1 mole to 10 moles.

This step is carried out in the presence of a basic substance. Examples of basic substances able to be used in this step include metal hydroxides such as sodium hydroxide or barium hydroxide; metal carbonates such as sodium carbonate or potassium carbonate, metal phosphates or hydrogen phosphates such as monosodium phosphate or potassium phosphate, basic ion exchange resins, organic tertiary amines such as triethylamine or tributylamine, and aromatic amines such as pyridine. Although the amount of the basic substance used is normally 1.5 moles to 5 moles with respect to 1 mole of the compound of formula (3), the amount used may also be 1 mole to 10 moles.

In addition, this step is carried out in the presence of an organic solvent. Although ether-based solvents such as tetrahydrofuran, diethyl ether, methyl-tert-butyl ether, 1,4-dioxane or 1,2-dimethoxyethane are used in this step, the previously listed aliphatic hydrocarbon solvents, aromatic solvents or halogenated hydrocarbon solvents may also be used. In addition, these solvents may be used alone or two or more solvents may be used simultaneously. Although the amount of the organic solvent used is normally 2 times to 20 times the weight of the compound of formula (3), the amount used may also be 1 time to 100 times the weight of the compound of formula (3).

The above-mentioned reaction between the compound of formula (3) and a (meth)acrylate halide compound or (meth)acrylic anhydride halide compound is carried out by a method consisting of gradually adding the (meth)acrylate halide compound or (meth)acrylic anhydride halide compound to a mixture containing the compound of formula (3), the basic substance and the organic solvent. More specifically, a mixture containing the compound of formula (3), the basic substance and the organic solvent is first held at a temperature of about −40° C. to 10° C. Next, while the (meth)acrylate halide compound or the (meth)acrylic anhydride halide compound is added to this mixture, the mixture is heated so that the temperature is increased to room temperature. Thus, a reaction is caused. The reaction time can be suitably adjusted to within the range of 1 hour to 6 hours. Progression of the reaction can be confirmed by GC, HPLC, TLC, IR or NMR.

The reaction solution is then mixed with water and subjected to liquid separation treatment by mixing with an organic solvent able to be separated from water. In this step, although an ester solvent such as methyl acetate, ethyl acetate or butyl acetate is used for the organic solvent able to be separated from water, the previously listed aliphatic hydrocarbon solvents, aromatic solvents or halogenated hydrocarbon solvents may also be used. There are no particular limitations on the amounts of water and organic solvent used in liquid separation treatment. The organic layer following liquid separation treatment is washed using water and an acidic aqueous solution, and then dehydrated and filtered as necessary.

(Step 3)

The third step is a step of obtaining a polymer precursor containing a repeating unit represented by the following formula (5) by addition polymerization of the compound of formula (4):

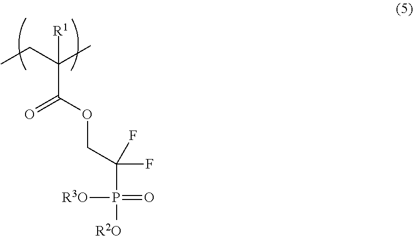

(wherein, R¹ represents a hydrogen atom or methyl group, and R² and R³ respectively and independently represent a linear or branched alkyl group having 1 to 5 carbon atoms).

The polymer precursor of formula (5) is obtained by polymerizing in accordance with a conventional ordinary method. A radical polymerization method consisting of dissolving the compound of formula (4) in a suitable solvent such as tetrahydrofuran, dimethylformamide, chloroform or toluene followed by adding a radical polymerization initiator and polymerizing at about 50° C. to 220° C., for example, can be used as a conventional polymerization method.

Examples of polymerization initiators able to be used in the radical polymerization method include azo compounds such as 2,2′-azobis(isobutyronitrile) (AIBN), 2,2′-azobis-(2,4′-dimethylvaleronitrile) or dimethyl 2,2′-azobis(isobutyrate), peroxides such as benzoyl peroxide (BPO), and persulfates such as potassium persulfate or ammonium persulfate. These may be used alone or two or more polymerization initiators may be used in combination: Although the amount of the polymerization initiator used is normally 0.001 moles to 0.1 moles with respect to 1 mole of the compound of formula (4), the amount used may also be 0.005 moles to 0.01 moles.

(Step 4)

This step is a step of reacting the polymer precursor of formula (5) with a de-esterification agent to convert the phosphate ester group of the polymer precursor of formula (5) to a phosphate group. The phosphonic acid polymer of the embodiment can be produced by performing this step.

In this step, the polymer precursor of formula (5) is reacted with a trialkylsilyl halide such as trimethylsilyl bromide (TMSBr), trimethylsilyl chloride, triethylsilyl chloride, t-butyldimethylsilyl chloride or trimethylsilyl iodide. Although the amount of the trialkylsilyl halide used is normally 1.5 moles to 3 moles with respect to 1 mole of phosphate ester groups of the polymer precursor of formula (5), the amount used may also be 1 mole to 5 moles.

This step is carried out in the presence of an organic solvent. Although a halogenated hydrocarbon solvent such as tetrachloroethane, dichloroethane, chloroform or methylene chloride is used in this step, the previously listed aliphatic hydrocarbon solvents, aromatic solvents or ether-based solvents may also be used. In addition, these solvents may be used alone or two or more solvents may be used simultaneously. Although the amount of the organic solvent used is normally 0.01 times to 0.1 times the weight of the polymer precursor of formula (5), the amount used may also be 0.01 times to 1 time the weight of the polymer precursor of formula (5).

The reaction between the polymer precursor of formula (5) and the trialkylsilyl halide is carried out according to a method consisting of gradually adding the trialkylsilyl halide to a mixture containing the polymer precursor of formula (5) and the organic solvent. More specifically, a mixture containing the polymer precursor of formula (5) and the organic solvent is first held at a temperature of about −40° C. to 10° C. Next, while the trialkylsilyl halide is added to this mixture, the mixture is heated so that the temperature thereof is increased to room temperature. The time period during which the reaction is caused can be suitably adjusted to within the range of 24 hours to 200 hours.

(Electrolyte Film for Fuel Cell)

Next, an explanation is provided of an electrolyte film for a fuel cell of the embodiment. The electrolyte film, for a fuel cell is obtained by a casting method consisting of dissolving or swelling the above-mentioned phosphonic acid polymer or, as necessary, a crosslinked form of the phosphonic acid polymer, in a solvent, and casting this onto a substrate to form a film. Furthermore, the electrolyte film for a fuel cell of the embodiment may also contain an antioxidant such as a phenolic hydroxyl group-containing compound, amine compound, organic phosphorous compound or organic sulfur compound.

In the case of crosslinking the phosphonic acid polymer of the embodiment, a radical polymerization method, for example, can be used in which the phosphonic acid polymer is dissolved in a suitable solvent such as water, tetrahydrofuran, dimethylformamide, chloroform or toluene, followed by adding a radical polymerization initiator and polymerizing at about 50° C. to 220° C. Examples of radical polymerization initiators that can be used include organic peroxides such as BPO, t-butyl hydroperoxide, or di-tert-butyl peroxide and inorganic peroxides such as potassium persulfate or ammonium persulfate, which are capable of generating polymer radicals by extracting hydrogen atoms present in polymer main chains. These peroxides may be used alone or two or more peroxides may be used in combination.

There are no particular limitations on the above-mentioned substrate provided it is a substrate used in ordinary solution casting methods, and examples of substrates used include plastic and metal substrates. Preferable examples of substrates used include polyethylene (PE) film, polytetrafluoroethylene (PTFE) film and polyethylene terephthalate (PET) film.

Examples of solvents used to dissolve or swell the phosphonic acid polymer of the embodiment include aprotic polar solvents such as N-methyl-2-pyrrolidone, N,N-dimethylformamide, γ-butyrolactone, N,N-dimethylacetoamide, dimethylsulfoxide, dimethyl urea or acetonitrile, chlorine-based solvents such as dichloromethane, chloroform, 1,2-dichloroethane, chlorobenzene or dichlorobenzene, alcohols such as methanol, ethanol, propanol, iso-propyl alcohol, sec-butyl alcohol or tert-butyl alcohol, alkylene glycol monoalkyl ethers such as ethylene glycol monomethyl ether, ethylene glycol monoethyl ether or propylene glycol monoethyl ether, and ketones such as acetone, methyl ethyl ketone, cyclohexanone or γ-butyl lactone. One type of these solvents may be used alone or two or more solvents may be used in combination.

Although varying according to the molecular weight of the polymer, the polymer concentration in the solvent in which the phosphonic acid polymer of the embodiment has been dissolved is normally 5% by weight to 40% by weight and preferably 7% by weight to 25% by weight. If the polymer concentration is below the above ranges, it becomes difficult to obtain a thick film and pinholes tend to form easily, while if the polymer concentration exceeds the above ranges, solution viscosity becomes excessively high, it becomes difficult to form a film and there is a lack of surface smoothness.

In addition, although varying according to the molecular weight of the polymer, polymer concentration, concentration of additives and the like, the solution viscosity is normally 2,000 mPa·s to 100,000 mPa·s and preferably 3,000 mPa·s to 50,000 mPa·s. If the solution viscosity is below the above ranges, retention of solution during deposition becomes poor and the solution ends up running off the substrate, while if the solution viscosity exceeds the above ranges, the viscosity becomes excessively high, thereby making it difficult to form a film.

Following deposition, when the resulting undried film is immersed in water, the solvent in the undried film can be replaced with water, enabling the amount of residual solvent in the film to be reduced. Furthermore, the undried film may be preliminarily dried before immersing the undried film in water following deposition. This preliminary drying is normally carried out by holding the undried film at a temperature of 10° C. to 60° C. for 0.1 hours to 10 hours.

When immersing the undried film (including the film following preliminarily drying, and to apply similarly hereinafter) in water, a batch process may be employed in which individual films are immersed in water, or a continuous process may be employed in which a laminated film in a state of being deposited on a substrate film (such as a PET film) as is, or a film that has been separated from the substrate, is immersed in water and then wound up. In addition, in the case of a batch process, the undried film is preferably immersed in water by using a method in which the film is fastened to a frame to inhibit the formation of wrinkles on the film surface after treatment.

Although a film is obtained in which the amount of residual solvent has been reduced when the undried film is dried after immersing in water as described above, the amount of residual solvent in a film obtained in this manner is normally 5% by weight or less. In addition, the amount of residual solvent in the resulting film can be made to be 1% by weight or less depending on the immersion conditions. An example of such conditions consists of using 50 parts by weight or more of water to 1 part by weight of the undried film, setting the temperature of the water during immersion to 10° C. to 60° C., and setting the immersion time to 10 minutes to 10 hours.

After haying immersed the undried film in water as described above, an electrolyte film for a fuel cell is obtained by vacuum-drying the film for 10 hours to 48 hours, and preferably 10 hours to 24 hours, at room temperature, and preferably at 10° C. to 60° C.

Although the following provides a more detailed explanation of the invention based on examples thereof, the invention is not limited to these examples.

### Synthesis Example 1

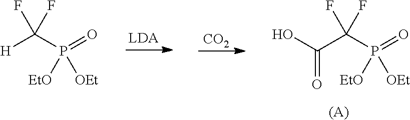

| | | | |
|---|---|---|---|
| 1) HCF₂PO(OEt)₂ | 20.0 | g | (106 mmol) |
| 2) Diisopropylamine | 11.84 | g | (117 mmol) |
| 3) 1.67M n-BuLi/hexane solution | 70 | ml | (117 mmol) |
| 4) THF (dehydrated) | 500 | ml | |
| 5) CO₂ gas | | | |

<Synthesis of Carboxylic Acid Form (Compound (A))>

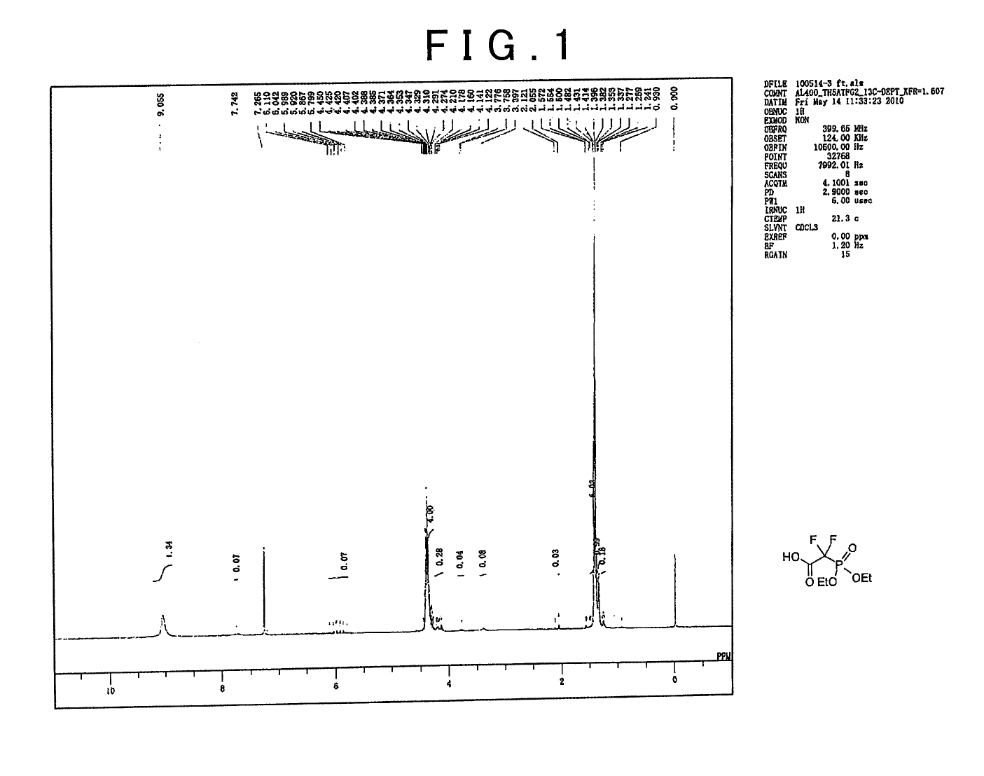

Diisopropylamine and 340 ml of THF (dehydrated) were charged into a 1 liter 4-mouth flask in an argon atmosphere followed by cooling to −70° C. Next, a 1.67 M n-BuLilhexane solution was dropped in at the same temperature followed by heating to 0° C. and stirring for 10 minutes. Next, the solution was again cooled to −70° C. followed by dropping in 160 ml of HCF₂PO(OEt)₂/THF (dehydrated) at the same temperature. After stirring for 30 minutes at −70° C., CO₂ gas dried by passing through concentrated sulfuric acid was bubbled through the reaction solution for about 50 minutes, at which time the temperature of the reaction solution rose to −20° C. The temperature of the reaction solution was gradually raised to 0° C., and after dropping in 3.2 ml of 2 M sulfuric acid and stirring for 15 minutes, about 120 ml of saturated aqueous sodium bicarbonate solution were added to make the solution alkaline. Subsequently, ether was added followed by stirring and liquid separation, and after adding 1 M sulfuric acid to the resulting aqueous layer to acidify, the aqueous layer was extracted three times with ethyl acetate followed by the further addition of NaCl to the aqueous layer and again extracting three times with ethyl acetate. The organic layer obtained by combining the extracts was dehydrated with MgSO₄ and filtered, and the filtrate was concentrated under reduced pressure to obtain 5.81 g of a pale brown oil (compound (A)). The ¹H-NMR chart of compound (A) is shown in FIG. 1.

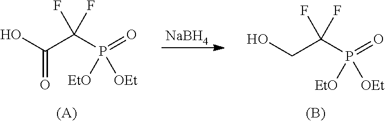

| | | | |
|---|---|---|---|
| 1) Compound (A) | 5.8 | g | (25 mmol) |
| 2) NaBH₄ | 2.83 | g | (75 mmol) |
| 3) THF (dehydrated) | 100 | ml | |

<Synthesis of Alcohol Form (Compound (B))>

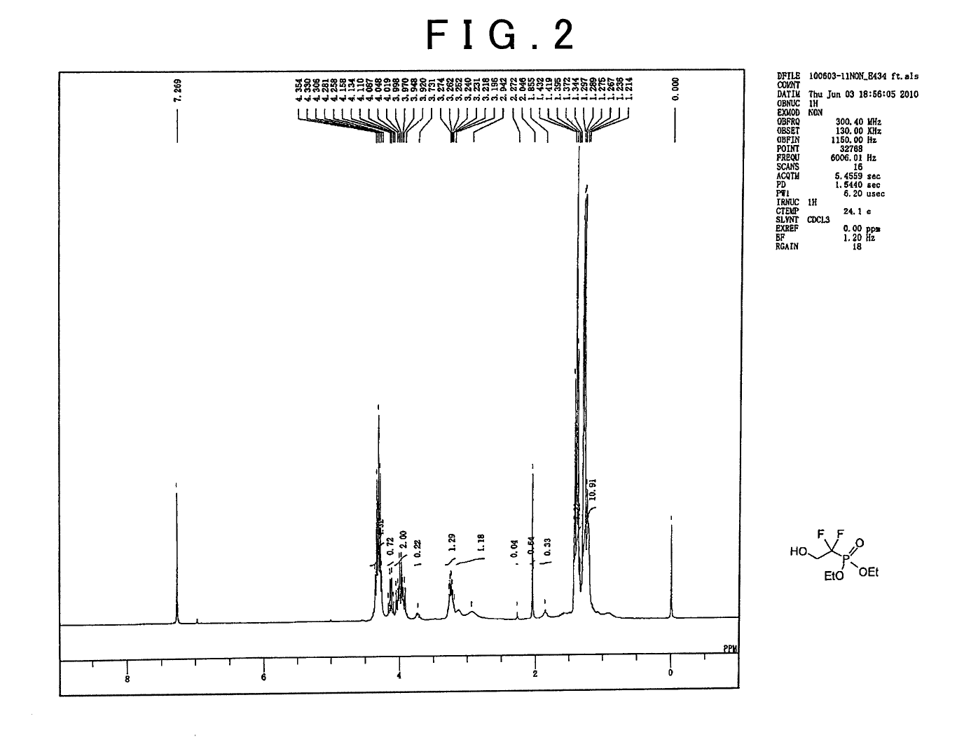

Compound (A) and THF (dehydrated) were charged into a 500 ml recovery flask in an argon atmosphere followed by cooling with ice water. NaBH₄ was added a little at a time followed by warming to room temperature and stirring overnight. The reaction solution was then injected into 200 ml of ice, water and extracted three times with ethyl acetate. The organic layer obtained by combining the extracts was washed with saturated salt solution, followed by dehydrating with MgSO₄, filtering and concentrating the filtrate under reduced pressure to obtain 3.2 g of a pale brown oil (compound (B)). The ¹H-NMR chart of compound (B) is shown in FIG. 2.

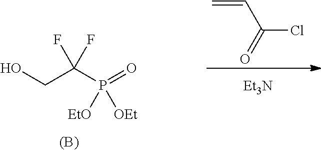

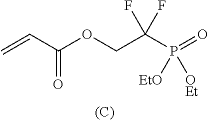 [SMILES: C=CC(=O)OCC(F)(F)P(=O)(OCC)OCC ; "(C)"]

| | | | |
|---|---|---|---|
| 1) Compound (B) | 1.53 | g | (7.0 mmol) |
| 2) Triethylamine | 2.19 | ml | (15.7 mmol) |
| 3) Acrylate chloride | 1.11 | ml | (13.7 mmol) |
| 4) THF (dehydrated) | 20 | ml | |

<Synthesis of Acrylate Form (Compound (C))>

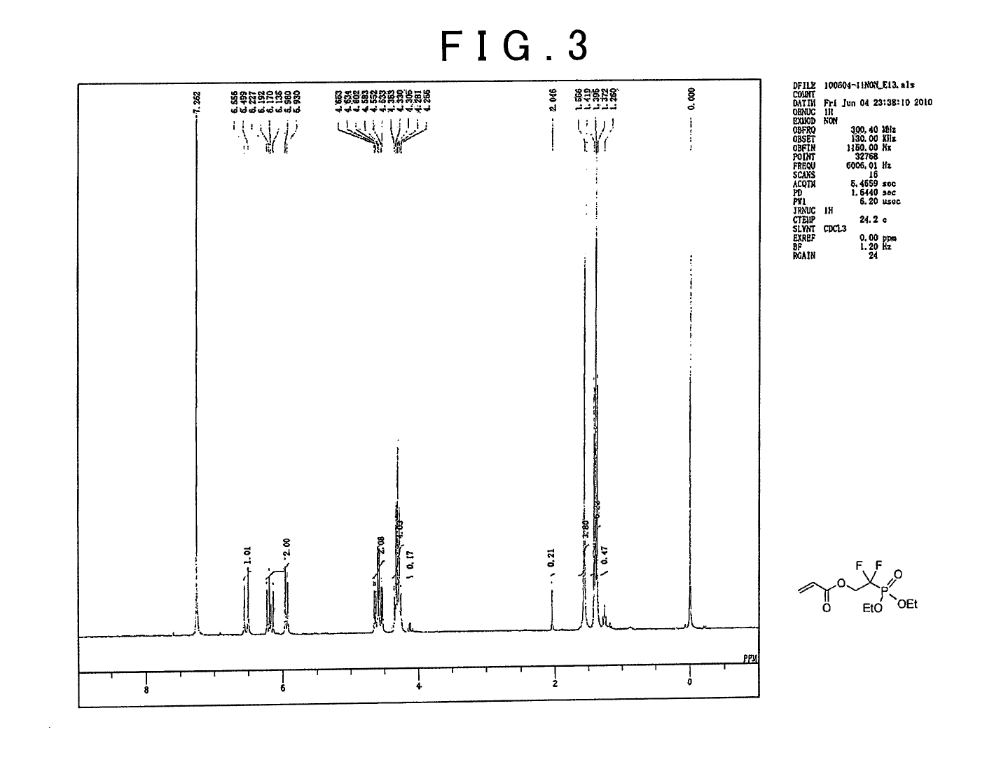

Compound (B), THF (dehydrated) and 1.46 ml of triethylamine were charged into a 100 ml recovery flask in an argon atmosphere followed by cooling with ice water. Although 0.74 ml of acrylate chloride were dropped in followed by warming to room temperature and checking the reaction by GC 1 hour later, compound (B) was found to have remained. Consequently, the reaction mixture was again cooled with ice water, and 0.73 ml of triethylamine and 0.37 ml of acrylate chloride were dropped in followed by warming to room temperature and stirring for 1 hour. Water was then injected into the reaction mixture followed by extracting three times with ethyl acetate. The organic layer obtained by combining the extracts was washed with saturated salt solution followed by dehydrating with MgSO₄, filtering and concentrating the filtrate under reduced pressure to obtain 1.3 g of a pale brown oil. The resulting oil was then purified with a silica gel column (silica gel: 25 g, hexane/ethyl acetate=4/1 to 2/1) to obtain 520 mg of an acrylate form (compound (C)). The ¹H-NMR chart of compound (C) is shown in FIG. 3.

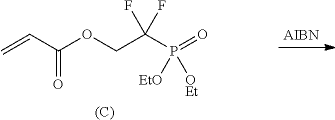 [SMILES: C=CC(=O)OCC(F)(F)P(=O)(OCC)OCC ; "(C)"]

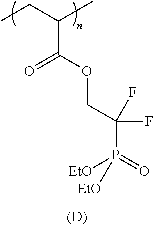

| | | | |
|---|---|---|---|
| 1) Compound (C) | 150 | mg | (0.55 mmol) |
| 2) AIBN | 0.75 | mg | (0.0046 mmol) |
| 3) Toluene (dehydrated) | 1.35 | g | |

<Synthesis of Phosphonate Ester Polymer (Compound (D))>

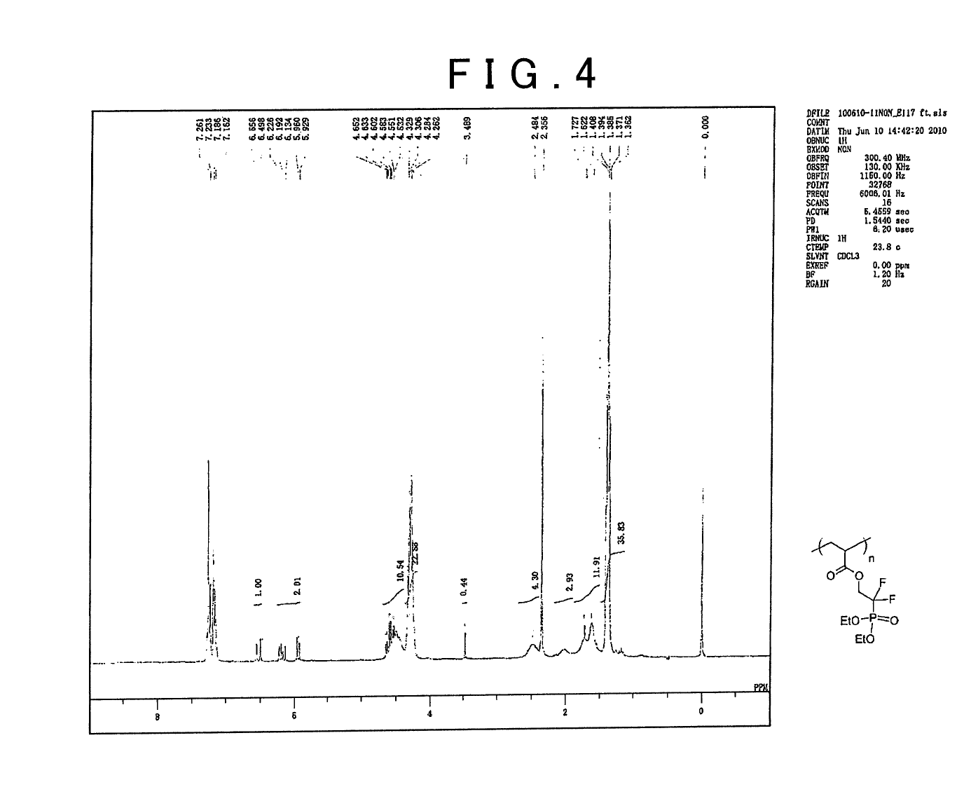

Compound (C), toluene (dehydrated) and AIBN were charged into a frozen ampule tube followed by carrying out a freezing deaeration procedure three times consisting of freezing the solution with liquid nitrogen, deaerating the inside of the ampule by drawing a vacuum therein and opening the ampule to nitrogen (by switching with a three-way stopcock). The ampule was sealed using a burner while still filled with nitrogen. Subsequently, the ampule was agitated and heated for 24 hours in a bath at 62° C. After allowing to cool to room temperature, the ampule was cut open followed by concentrating under reduced pressure and washing the residue with hexane to obtain 92 mg of a viscous oil (compound (D)). The ¹H-NMR chart of compound (D) is shown in FIG. 4. The number average molecular weight (Mn) and weight average molecular weight (Mw) of the polymer as determined by gel permeation chromatography (GPC) were 9.826 and 21,528, respectively. Furthermore, these values were determined as polystyrene when measured using a Waters RI Detector (Model 2414 Differential Refractometer) and two Shodex KD-806M columns under conditions consisting of the use of NMP containing 0.01 M LiBr for the developing solvent, and a column temperature of 40° C.

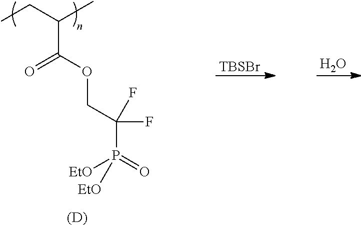

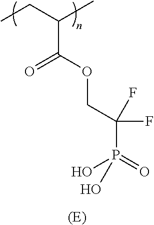

| | | | |
|---|---|---|---|
| 1) Compound (D) | 45 | mg | |
| 2) TMSBr | 189 | mg | (1.2 mmol) |
| 3) Chloroform (dehydrated) | 1 | ml | |

<Synthesis of Phosphonic Acid Polymer (Compound (E))>

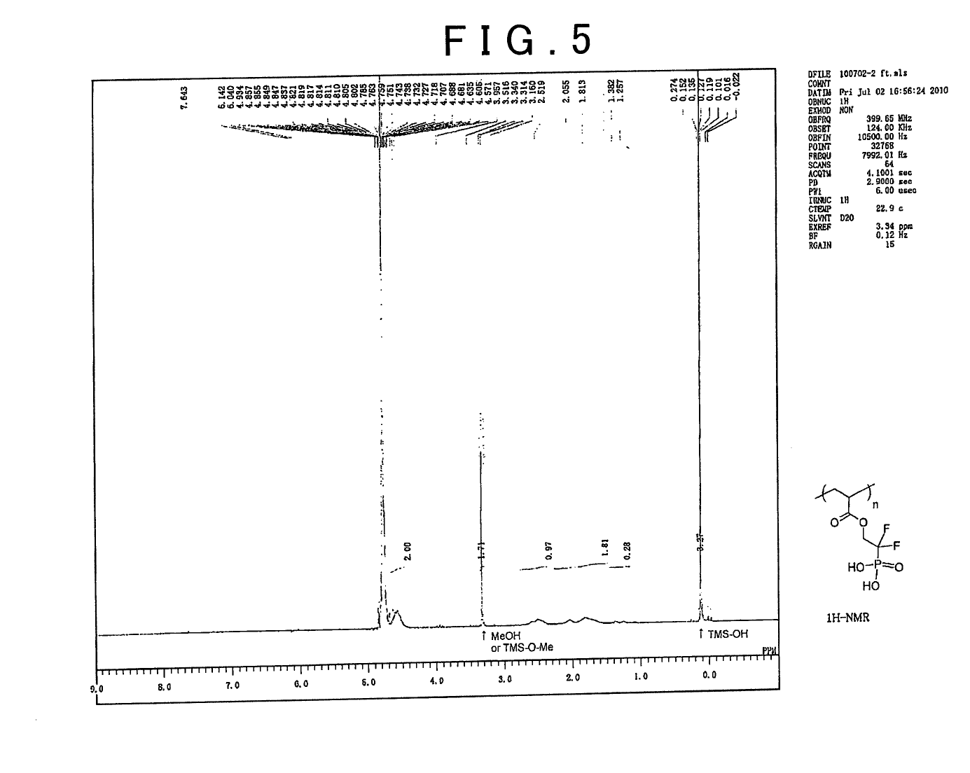

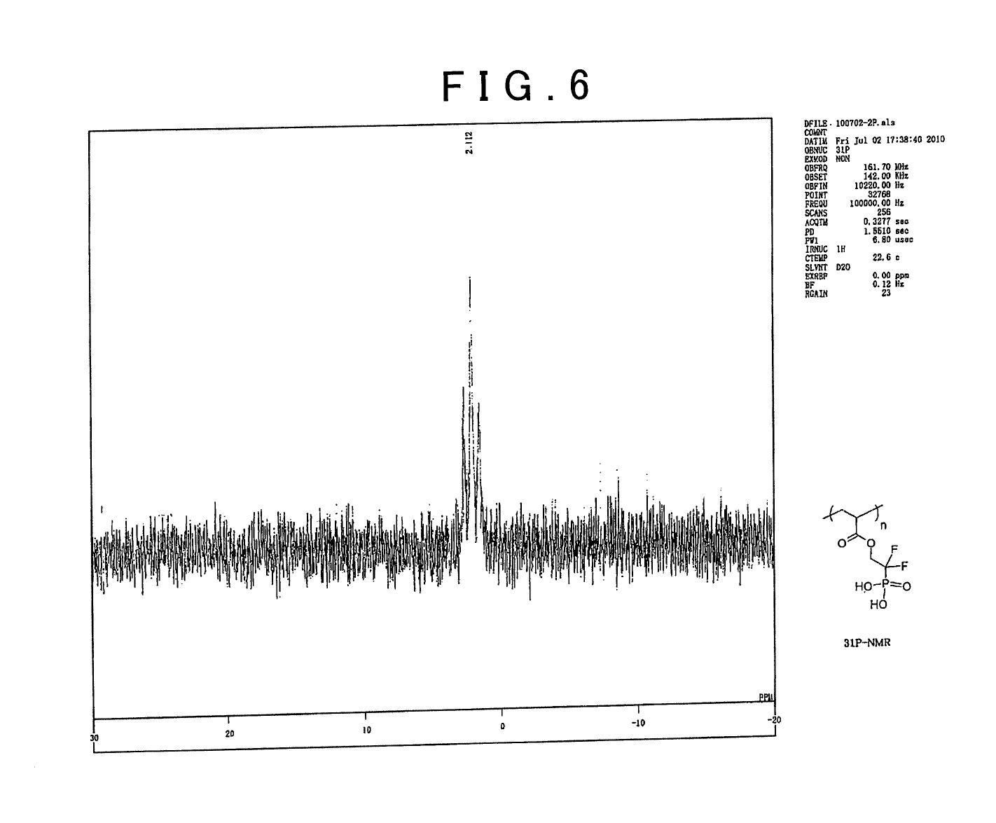

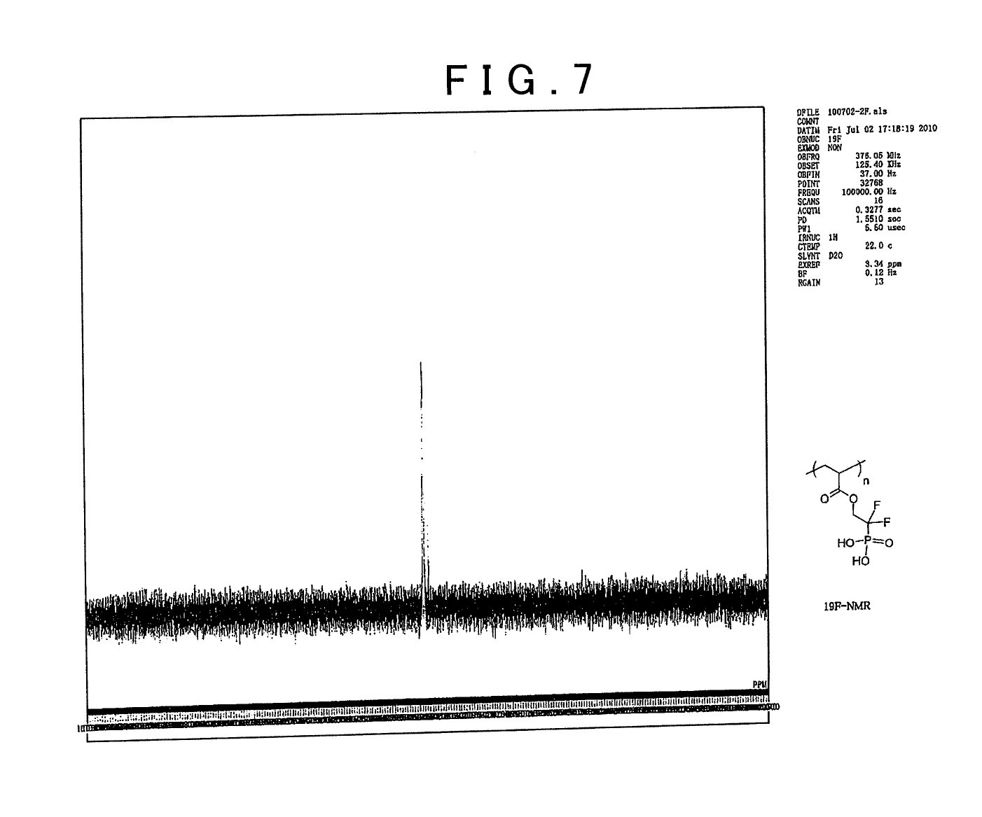

Compound (D) and chloroform (dehydrated) were charged into a 10 ml recovery flask in an argon atmosphere and cooled with ice water followed by dropping in TMSBr and warming to room temperature. After allowing to react at room temperature for 3 days, 1 ml of water was added followed by concentrating under reduced pressure to obtain 30 mg of a viscous oil. The ¹H-NMR chart of this oil is shown in FIG. 5, the ³¹P-NMR chart is shown in FIG. 6, and the ¹⁹F-NMR chart is shown in FIG. 7.

### Synthesis Example 2

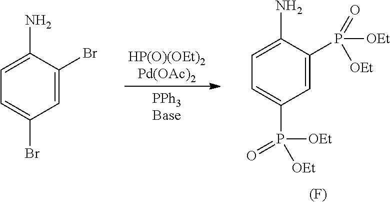

<Synthesis of 2,4-bis(diethyloxyphosphonoyl)aniline (DPA) (Compound (F))>

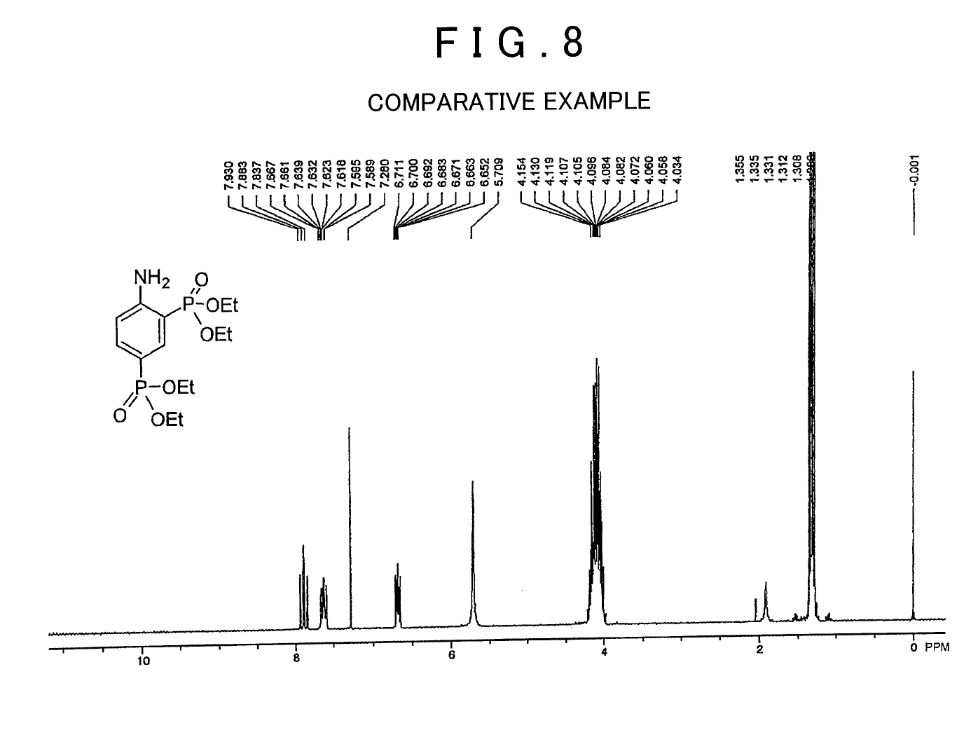

5.0184 g (20 mmol) of 2,4-dibromoaniline, 0.4490 g of palladium acetate and 1.5737 g (6.0 mmol) of triphenylphosphine were placed in a 200 ml two-mouth recovery flask equipped with a stirrer followed by replacing the atmosphere inside the flask with nitrogen. Continuing, 120 ml of ethanol were added followed by the addition of 12.4 ml (96 mmol) of diethyl phosphite and 12.7 ml (60 mmol) of dicyclohexylmethylamine, attaching a cooling pipe and stirring for 48 hours at 95° C. in a nitrogen atmosphere. Following completion of the reaction, allowing to return to room temperature and distilling off the solvent, the residue was dissolved in methylene chloride and extracted. The extract was washed four times with 2 M aqueous hydrochloric acid and once with water and then dehydrated with anhydrous magnesium sulfate. Subsequently, the solvent was distilled off to obtain a crude product. The crude product was purified by column chromatography (ethyl acetate:hexane=50:1) followed by distilling off the solvent and concentrating under reduced pressure to obtain 5.0246 g of an oily yellow liquid (yield: 68%) (compound (F)). The ¹H-NMR chart of compound (F) is shown in FIG. 8.

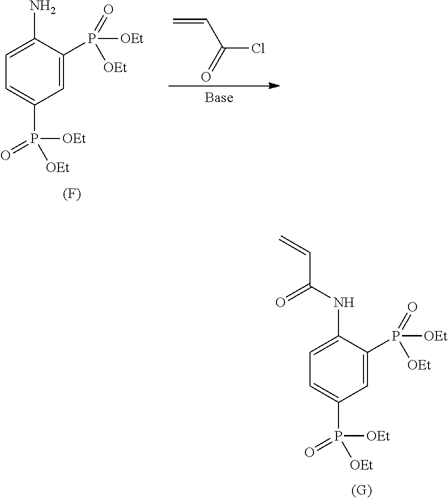

<Synthesis of N-[2,4-bis(diethoxyphosphonoyl)phenyl]acrylamide (Compound (G))>

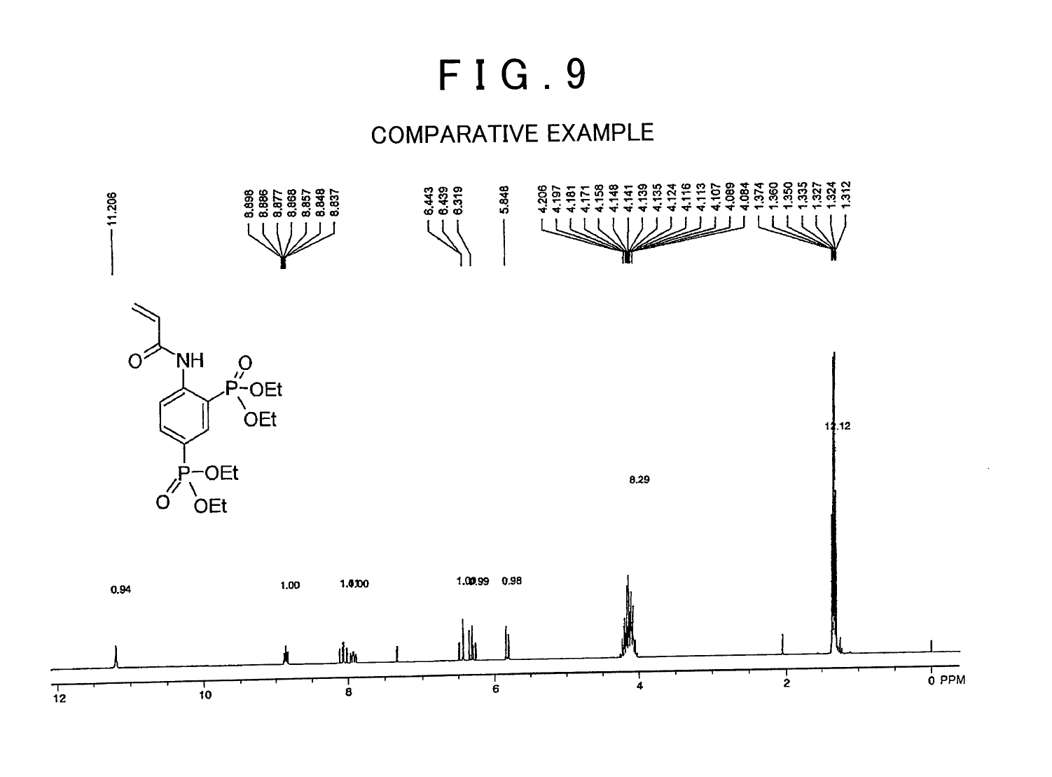

2.9224 g (8.0 mmol) of the synthesized compound (F) were placed in a 30 ml two-mouth recovery flask equipped with a stirrer followed by replacing the atmosphere inside the flask with nitrogen. 8 ml (11.1 mmol) of dehydrated THF and 1.0 ml (12.8 mmol) of dehydrated pyridine were placed therein followed by cooling the reaction mixture to 0° C. After having cooled to 0° C., 1.0 ml (12.8 mmol) of acryloyl chloride was added followed by stirring for 1 hour at room temperature. Following completion of the reaction, water was added followed by extraction with methylene chloride. After washing three times with saturated aqueous sodium bicarbonate solution and once with water, the reaction mixture was dehydrated with anhydrous magnesium sulfate followed by distilling off the solvent to obtain a crude product. The crude product was purified by column chromatography (ethyl acetate) followed by distilling off the solvent and drying under reduced pressure to obtain 1.1195 g of a white crystalline solid (yield: 33%) (compound (G)). The ¹H-NMR chart of compound (G) is shown in FIG. 9.

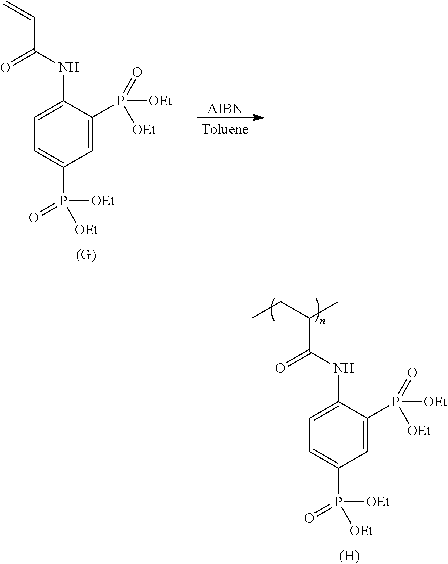

### Synthesis of Poly-N[2,4-bis(diethoxyphosphonoyl)phenyl]acrylamide (Compound (H))

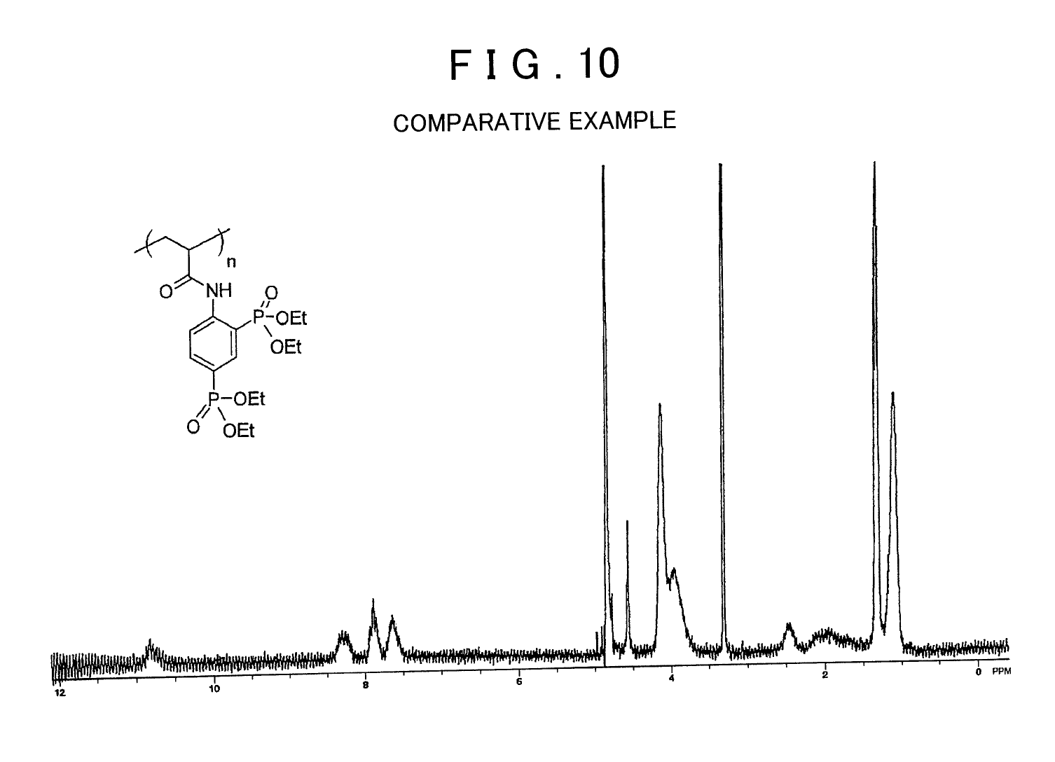

1 g (0.00238 mol) of the synthesized compound (G), 0.013 g (0.0000785 mol) of azoisobutyronitrile and 9 g of toluene were added to an ampule tube, and after solidifying with liquid nitrogen, oxygen was adequately removed by replacing with argon gas. Subsequently, the ampule tube was sealed and agitated for 24 hours at 60° C. Following agitation, the reaction mixture was re-precipitated in hexane to obtain 0.4 g of the target compound (H) (yield: 40%) (compound (H)). The ¹H-NMR chart of compound (H) is shown in FIG. 10.

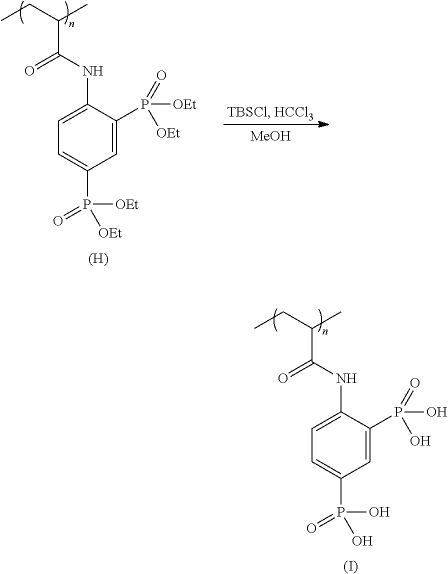

<Synthesis of Compound (I)>

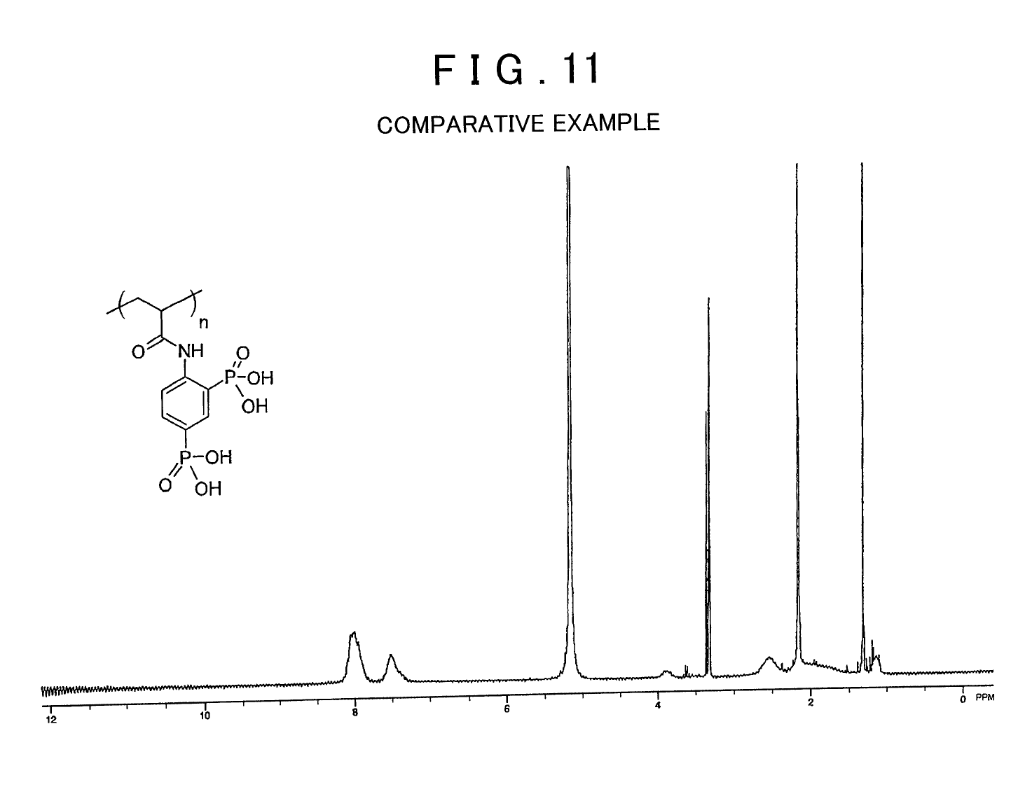

0.15 g of the synthesized compound (H) were dissolved in 15 ml of chloroform followed by dropping in 0.51 g (0.0033 mol) of t-butyldimethylsilyl chloride at 50° C. After heating the reaction solution to 40° C. and allowing to react for 24 hours, the reaction solution was re-precipitated in methanol. After washing with methanol, the reaction solution was dried under reduced pressure at 80° C. to obtain 0.565 g of the target compound (I) (yield: 97%) (compound (I)). The ¹H-NMR chart of compound (I) is shown in FIG. 11.

[Production of Film Samples]

Polymer powders of compound (E) obtained in Synthesis Example 1 and compound (I) obtained in Synthesis Example 2 were dissolved to 20% by weight in ethanol and coated onto PTFE to a film thickness of 50 μm. Following coating, the coated films were dried for 1 hour at 80° C. with a hot air dryer to obtain two types of films. Among these, the film produced from compound (E) was used for the sample of Example 1, while the film produced from compound (I) was used for the sample of Comparative Example 1.

In addition, 0.1285 g (0.60 mmol) of compound (E) obtained in Synthesis Example 1 were added to a methanol solution in which was dissolved 0.010 g (0.030 mmol) of 5 mol % BPO, and this mixed solution was coated onto a PTFE sheet so that the film thickness after drying was 150 μm. Continuing, the mixed solution on the PTFE sheet was incrementally heated at 10° C. per hour from 40° C. to 100° C. to obtain a crosslinked film. In contrast to compound (E) demonstrating water solubility, this crosslinked film was not observed to dissolve even when immersed for 24 hours in water at 25° C. This crosslinked film was used for the sample of Example 2.

<Measurement Methods and Evaluation>

(1) Measurement of EW Value

After drying each of the samples of Example 1 and Comparative Example 1 under reduced pressure for 24 hours at 100° C., the samples were transferred to a biological safety cabinet (glove box) containing an argon atmosphere and allowed to stand for 30, minutes followed by measurement of the weight thereof. The samples were then dissolved in N,N-dimethylacetoamide and titrated with a 0.1 mol/l aqueous solution of tetramethylammonium hydroxide. The point at which the pH reached 7 was taken to be the equivalence point, and EW value was calculated from the amount of aqueous tetramethylammonium hydroxide solution added at that time.

EW value (g/mol)=1000×sample weight (g)/0.1 (mol/l)×titrated amount of tetramethylammonium hydroxide (ml)

As a result, the EW value of the sample of Example 1 was 215 g/mol. On the other hand, the EW value of the sample of Comparative Example 1 was 265 g/mol.

(2) Measurement of Proton Conductivity in Atmosphere at 80° C.

The samples of Example 1, Example 2 and Comparative Example 1 were each cut into strips measuring 10 mm×30 mm, and both ends thereof were placed between a metal plate (5 mm×50 mm) followed by positioning between Teflon® measuring probes to prepare a laminates of each sample. Next, resistance between the platinum plates was measured in an atmosphere at 80° C. using a 1260 Frequency Response Analyzer manufactured by Solartron. During measurement, the humidity of the laminates was varied over a range of 20% to 90%. Proton conductivity was determined using the following equation.

Proton conductivity (S/cm)=distance between platinum plates (cm)/(sample film width (cm)×sample film thickness (cm)×resistance (Ω))

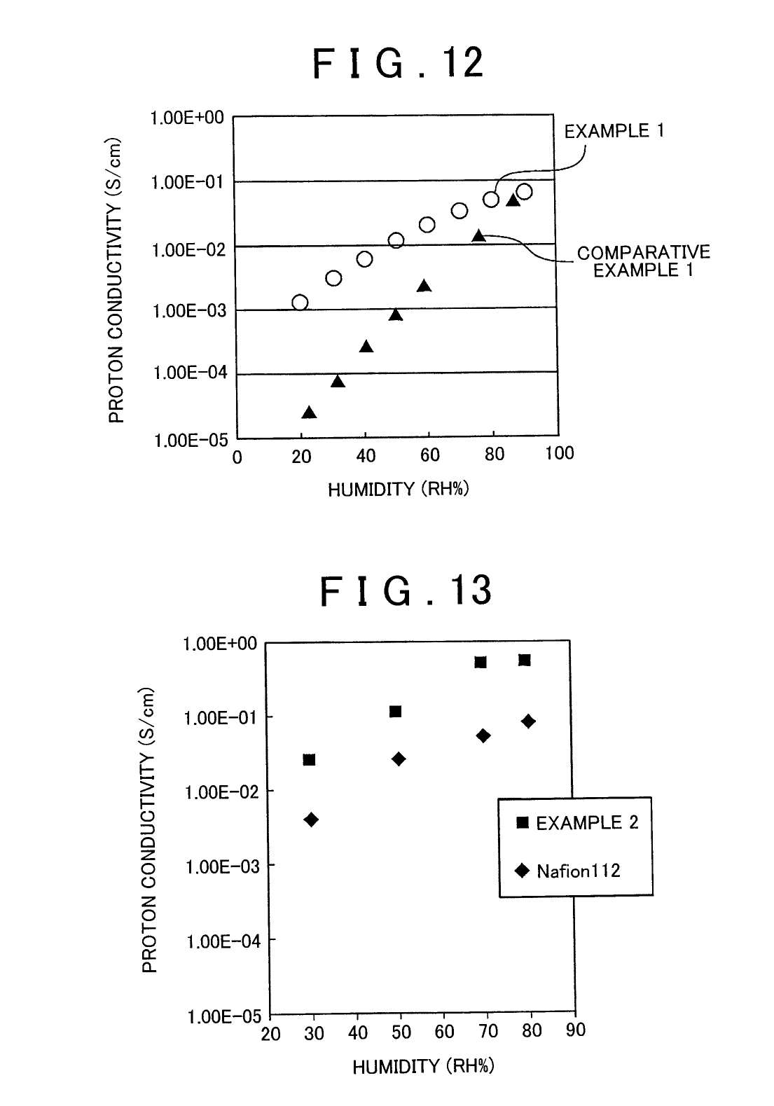

The results obtained for proton conductivity are shown in FIGS. 12 and 13. As can be seen from FIG. 12, the sample of Example 1 demonstrated higher proton conductivity than the sample of Comparative Example 1 over the entire range of measurement conditions. The sample of Example 1 demonstrated higher values than the sample of Comparative Example 1 under low humidity conditions (up to 60%) in particular. On the basis thereof, the sample of Example 1 was determined to have a high proton conductivity and be able to be used even at low humidity.

In addition, as can be seen from FIG. 13, the sample of Example 2 demonstrated higher proton conductivity than the Nafion® sample over the entire range of measurement conditions. On the basis thereof, proton conductivity was determined to be improved considerably as a result of crosslinking the phosphonic acid polymer of the embodiment. Although the details of the reason for the obtaining of these results are unclear, it is thought that partial acid density is improved as a result of intramolecular crosslinking of the phosphonic acid polymer.

(3) Measurement of Moisture Absorption λ

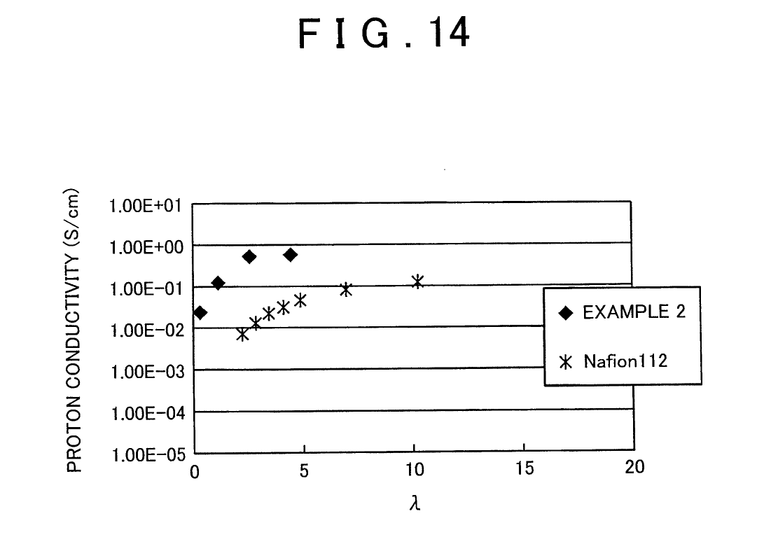

Proton conductivity and moisture absorption λ at various humidity levels were measured for the sample of Example 2 using a polymer film moisture absorption analyzer (MSB-AD-FC) manufactured by Bell Japan. More specifically, after allowing the sample of Example 2 to stand for 30 minutes under vacuum conditions at 80° C., proton conductivity and moisture absorption were determined after holding the sample for 2 hours at the prescribed humidity. In addition, proton conductivity and moisture absorption were also determined for a Nafion® sample under the same measurement conditions as those used for the sample of Example 2. The determined amount of moisture absorption was defined as the amount of moisture absorbed λ per acidic group (phosphonic acid or sulfonic acid) contained in the sample. FIG. 14 indicates the relationship between moisture absorption λ and proton conductivity. As can be seen from FIG. 14, the sample of Example 2 demonstrated higher proton conductivity than the Nafion® sample at low levels of moisture absorption λ. On the basis thereof, the sample of Example 2 was determined to demonstrate better proton conductivity than the Nafion® sample while minimizing swelling caused by water.

(4) Evaluation of Oxidation Stability

After cutting to a size measuring 3 cm×3 cm, the sample of Example 2 was immersed for 24 hours in a Fenton test solution (3% aqueous H₂O₂ solution containing 20 ppm of FeSO₄). Following completion of immersion, the sample piece was removed with a tweezers, placed in a sample bag and vacuum-dried for 24 hours at 50° C. Following vacuum-drying, the weight of the sample piece was measured. In addition, a sample piece of the sulfonate polyimide (compound (J)) indicated in Y. Yinetal, Polymer, 44, 4509-4518, 2003 was weighed under the same measurement conditions as those of the sample of Example 2 for comparison purposes.

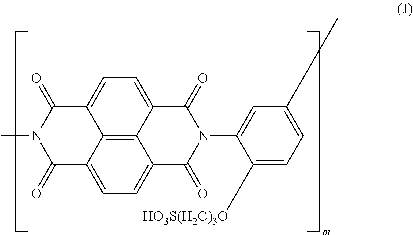

The results of the Fenton test are shown in the following Table 1. Furthermore, the weight retention ratio shown in the following Table 1 refers to the ratio of the weight of the sample piece before and after the Fenton test, and a higher value for this ratio indicates higher radical resistance. As can be seen from Table 1, the sample of Example 2 was shown to also be provided with radical resistance in addition to the previously described properties.

TABLE 1

| Example 2 | Did not dissolve (weight retention ratio of 90% or more) |
|---|---|
| compound (J) | Dissolved |

1. A phosphonic acid polymer containing a repeating unit represented by the following formula (1): 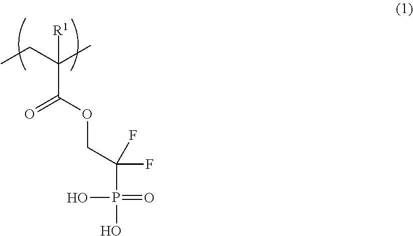
(wherein, R¹ represents a hydrogen atom or methyl group).

2. An electrolyte film for a fuel cell, comprising:
the phosphonic acid polymer according to claim 1.

3. An electrolyte film for a fuel cell, comprising:
a crosslinked form of the phosphonic acid polymer according to claim 1.

4. A production method of the phosphonic acid polymer according to claim 1, comprising:
reacting a reducing agent with a carboxyl group-containing compound represented by the following formula (2) to obtain a hydroxymethyl group-containing compound represented by the following formula (3);
reacting a (meth)acrylate halide compound or (meth)acrylic anhydride halide compound with the hydroxymethyl group-containing compound to obtain a (meth)acrylic acid-based compound represented by the following formula (4);
addition-polymerizing the (meth)acrylic acid-based compound to obtain a polymer precursor containing a repeating unit represented by the following formula (5): 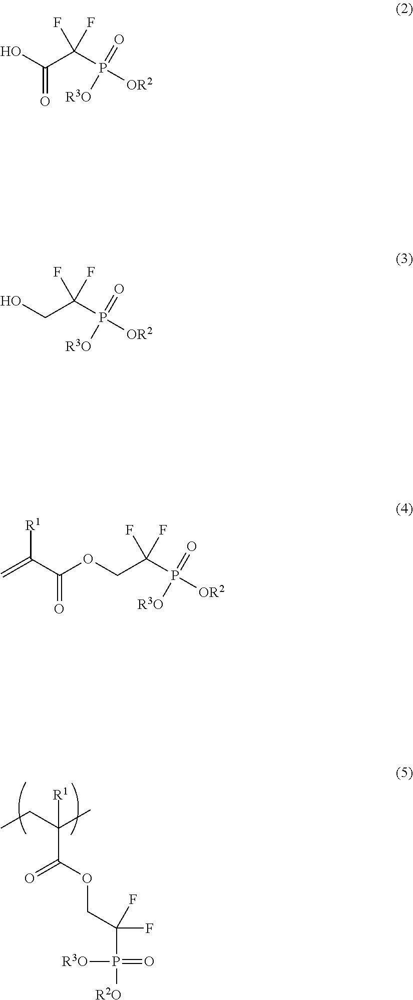
(wherein, R¹ represents a hydrogen atom or methyl group, and R² and R³ respectively and independently represent a linear or branched alkyl group having 1 to 5 carbon atoms); and
hydrolyzing an ester moiety of the polymer precursor.
